(19) United States
(12) Patent Application Publication
(10) Pub. No.: US 2007/0286966 A1
(43) Pub. Date: Dec. 13, 2007

(54) METHOD OF DEPOSITING AN ABRASION-RESISTANT LAYER ONTO AN ELECTROLUMINESCENT PLASTIC WINDOW

(76) Inventors: Meng Chen, Novi, MI (US); Chengtao Li, Novi, MI (US)

Correspondence Address: BRINKS HOFER GILSON & LIONE, P.O. BOX 10395, CHICAGO, IL, 60610, US

(21) Appl. No.: 11/423,269

(22) Filed: Jun. 9, 2006

(51) Int. Cl. B05D 3/00; B05D 1/36; H05H 1/24; B05D 3/02

(52) U.S. Cl. 427/569; 427/299; 427/402; 427/384

(57) ABSTRACT

A method for applying an abrasion resistant layer via a vacuum deposition technique to a plastic automotive window is provided. The plastic automotive window includes a plastic panel, an electroluminescent layer, and a weatherable layer. A first abrasion resistant sub-layer is then deposed on top of the weatherable layer, and a second abrasion resistant sub-layer is then applied onto the first abrasion resistant sub-layer. The deposition of the abrasion resistant sub-layers is carried out under controlled temperature conditions that reduce adhesion loss within the electroluminescent layer and maintains the electroluminescent functionality of that layer.

### BACKGROUND OF THE INVENTION

The present invention relates generally to the field of automotive plastic windows. More specifically, it relates to a method for applying an abrasion-resistant layer to the interior and/or exterior surface of electroluminescent plastic windows.

Plastic window systems are beginning to replace traditional glass windows in the automotive industry. Since plastic materials exhibit different properties than inorganic (e.g., glass) materials, various new processes for manufacturing these window systems have to be developed. One such process is the multi-step process used to manufacture the Exatec® 900 and 900 vt plastic glazing system offered by Exatec, LLC (Wixom, Mich.). This process includes (1) molding the window from a plastic resin; (2) printing an optional decoration or added functionality (e.g., defroster, etc.) layer using 3-D printing methodology; (3) applying a weatherable layer using conventional flow, dip, or spray coating techniques; and (4) applying an abrasion-resistant layer through the use of plasma enhanced chemical vapor deposition (PECVD).

A key component in the manufacturing of a plastic window system comprising multiple interfacial regions between different material layers is the compatibility in both chemistry and properties that exists between the layers. A process that is developed to optimize the compatibility between two material layers may not work if one of the material layers is replaced with a different material layer. For example, in the Exatec® 900vt glazing system, the abrasion-resistant layer is optimized to exhibit optical clarity, hardness, and adhesion to both the surface of the polycarbonate window and a silicone weathering layer. However, adhesion failure occurs when another layer, such as an electroluminescent layer, is placed between the abrasion-resistant layer and the polycarbonate substrate. The observed adhesion loss occurs due to non-uniform heating across the multiple sub-layers that comprise the electroluminescent layer. Furthermore, the exposure to inert gases, such as a mixture of argon and oxygen, during the PECVD application of an abrasion-resistant layer can facilitate a loss in the properties associated with the electroluminescent layer.

In view of the above, it is apparent that there is a need in the industry for a process suitable for the application of an abrasion-resistant layer to a plastic window system that comprises an electroluminescent layer without causing any adhesion loss or loss in electroluminescence.

### BRIEF SUMMARY OF THE INVENTION

An object of the present invention is to provide a method for the application of an abrasion resistant layer to a plastic automotive window comprising an electroluminescent layer. Another object of the invention is to enhance the abrasion resistance of the electroluminescent automotive window through the optimized application of the abrasion-resistant layer. Yet another object of the invention is to deposit an abrasion-resistant layer while minimizing the occurrence of any adhesion loss between the various layers that comprise the electroluminescent layer, as well as maintaining the electroluminescent properties of the layer.

A plastic automotive window embodying the principles of the present invention is a multi-layer glazing system, having a plastic panel, an electroluminescent layer, a weatherable layer, and an abrasion-resistant layer, among other layers. The electroluminescent layer may be encapsulated as part of the plastic panel through the use of a film insert molding (FIM) process. The weatherable layer is applied and cured under conditions (e.g., temperature, etc.) that further reduce the chance of any adhesion loss within the electroluminescent layer and prevent warpage of the plastic automotive window. The abrasion-resistant layer may comprise multiple sub-layers in order to reduce adhesion loss and deposit a layer providing a high level of abrasion resistance. The various embodiments of the present invention provide an advantageous method for the application of an abrasion-resistant layer that can be practiced when the plastic automotive window comprises an electroluminescent layer.

Other objects and advantages of the present invention will become apparent upon considering the following detailed description and appended claims, and upon reference to the accompanying drawings.

### BRIEF DESCRIPTION OF THE DRAWINGS

FIG. 1 represents a fragmentary side view of an automobile incorporating a plastic automotive window, in accordance with the principles of the present invention.

FIG. 2 is a schematic illustrating the various layers that comprise a plastic automotive window, in accordance with one embodiment of the present invention.

FIG. 3 is a schematic illustrating the various layers that comprise a plastic automotive window, in accordance with another embodiment of the present invention utilizing a film insert molding (FIM) process.

FIG. 4 provides both a horizontal (side) view and a vertical (top) view of a part carrier and an expanding thermal plasma PECVD reactor system, in accordance with a preferred embodiment of the present invention.

FIG. 5 shows a flow chart illustrating a method for depositing an abrasion resistant layer onto a plastic automotive window including an electroluminescent layer, in accordance with one embodiment of the present invention.

### DETAILED DESCRIPTION OF THE INVENTION

The following description of the preferred embodiment is merely exemplary in nature and is in no way intended to limit the invention or its application or uses.

The various embodiments of the invention provide a method or process for the application of an abrasion-resistant layer to a plastic automotive window. The automotive window is a multi-layer glazing system having a plastic panel, an electroluminescent layer, a weatherable layer, and an abrasion-resistant layer. As further discussed below, the electroluminescent layer may be deposited on the surface of the plastic panel or encapsulated as part of the plastic panel through the use of a film insert molding (FIM) process.

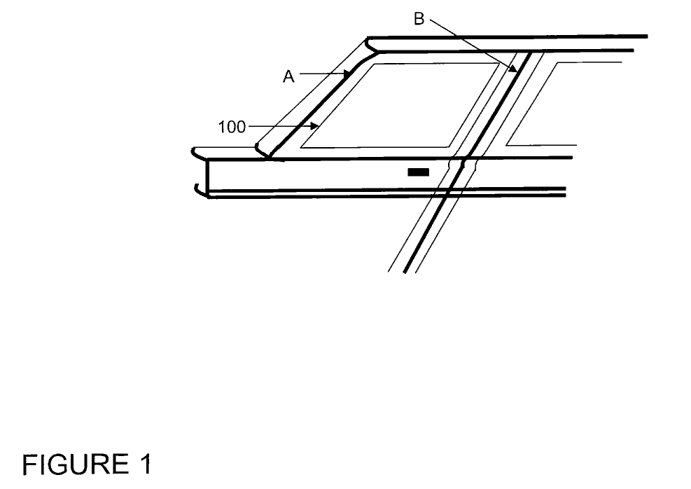

FIG. 1 shows a fragmentary side view of an automobile with a plastic automotive window 100, in accordance with one embodiment of the present invention. While the plastic automotive window 100 may be placed at various locations on the automobile, as shown it is located between structural members A & B of the automobile. The automotive window 100 includes two surfaces, namely, a first surface 10 and a second surface 20. As used herein, the first surface 10 faces the exterior of the automobile, while the second surface 20 faces the interior of the automobile.

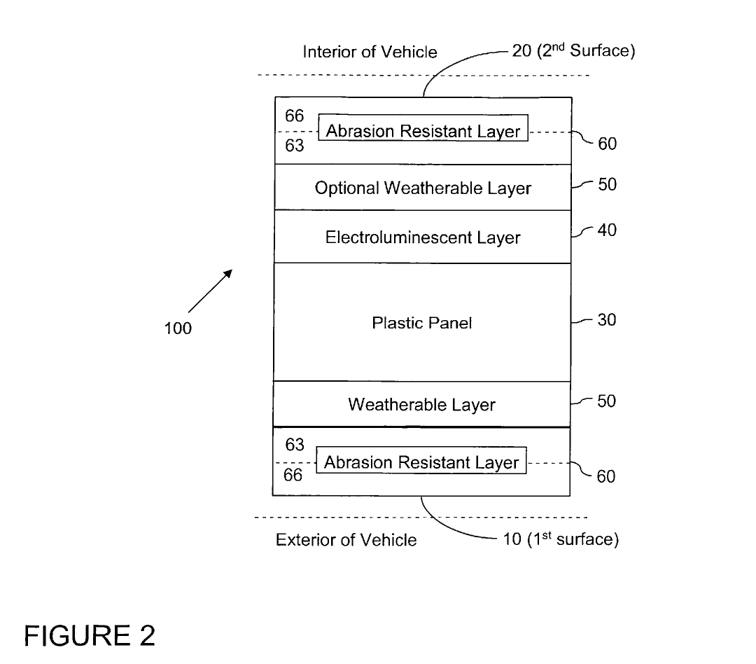

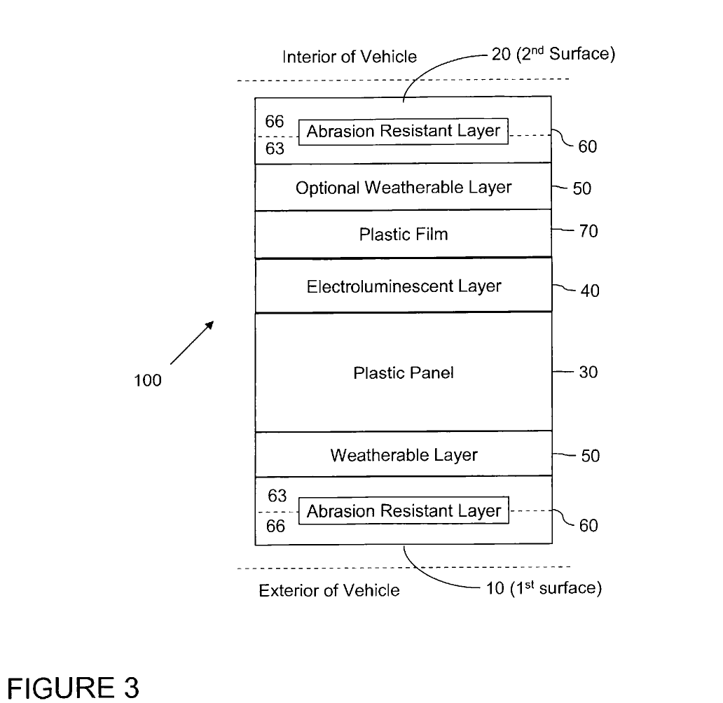

In one embodiment of the present invention, the automotive window 100 includes a plastic panel 30 upon which an electroluminescent layer 40 is disposed so as to be oriented toward the second surface 20 of the window as shown in FIG. 2. In another embodiment of the present invention, the electroluminescent layer 40 is deposited on the plastic panel 30 so as to be oriented toward the first surface 10 of the window, as shown in FIG. 3.

The electroluminescent layer 40 is a multiple-layer system that undergoes electroluminescence, e.g., emits light when an electric field is applied. The electroluminescent layer 40 may be a border or frame around part or all of the window or may be a design (such as artwork and/or words) or a solid band or lines placed as part of the frame or border or transition into or through the transparent visual area of the window. The electroluminescent layer may be deposited or printed using any technique known to those skilled in the art including, but not limited to, screen printing, ink jet printing, membrane image transfer, and mask and spray.

The electroluminescent layer 40 may include several sub-layers, such as a phosphor sub-layer, a dielectric sub-layer, a conductive paste sub-layer, a decorative ink sub-layer or other sub-layer. The phosphor sub-layer is the sub-layer responsible for emitting light when an electric field is applied across it, while the dielectric sub-layers provide the necessary capacitance and the conductive paste sub-layer provides optimum heat transfer across all of the above-mentioned sub-layers. The electroluminescent layer is described in more detail in U.S. patent application Ser. No. 11/317,587 submitted on Dec. 23, 2005, entitled “Light Emissive Plastic Glazing”, the entirety of which is hereby incorporated by reference.

In another embodiment of the present invention, the electroluminescent layer 40 may be encapsulated between the plastic panel 30 and a plastic film 70 by a process well known to those skilled in the art of molding as film insert molding (FIM). The film insert molding process is meant to include a series of sub-processes, including but not limited or restricted to forming the film by extrusion or other means, screen printing the electroluminescent layer 40 onto the film 70, optionally thermoforming the film to the geometry of one mold surface, trimming the film, inserting the film into the mold cavity, and injecting a molten plastic resin that will melt bond with the plastic film 70, and solidifying the plastic resin into the plastic panel 30 upon cooling. The screen-printing sub-process may also comprise printing additional optional sub-layers, such as graphics onto the electroluminescent layer 40, using a dielectric ink. The thermoforming sub-process includes forming the electroluminescent layer 40 into a geometry that will properly fit in the mold's cavity. Examples of thermoforming sub-processes include, but are not limited to, vacuum forming and pressure-assisted forming. The trimming sub-process removes excess plastic film 70, which is necessary to insure accurate insertion of the film into the injection-molding tool. Examples of trimming sub-processes include, but are not limited to, match-metal trimming, routering, and laser trimming. The injection molding sub-process includes forcing the plastic resin layer to make contact with the electroluminescent layer 40 and plastic film 70, which are placed in a mold cavity. The molten plastic resin is shot into the mold, causing melt bonding of the plastic film 70 with the plastic panel that solidifies upon cooling the molten plastic resin. In one embodiment of the present invention, the injection-molding process is performed at a mold temperature less than about 85° C.

The weatherable layer 50 may be applied by using any wet coating process known to those skilled in the art including, but not limited to, spray-coating, dip-coating, flow-coating, spin-coating, roll coating, and curtain coating processes. The weatherable layer 50 is deposited on to the electroluminescent layer 40, the plastic panel 30, and the plastic film 70 as shown in FIGS. 2 and 3. The application of the weatherable layer is preferably done to both the interior side 20 of the window (2^{nd} surface) and the exterior side 10 of the window (1^{st} surface) or to just the exterior side 10 of the window (1^{st} surface). Thus, the weatherable layer on the interior side 20 of the window (2^{nd} surface) is optional.

The weathering layer 50 may include, but is not limited to, silicones, polyurethanes, acrylics, polyarylate, epoxies, and mixtures or copolymers thereof. The weathering layer 50 may be extruded or cast as a thin film or applied as a discrete coating. The weathering layer 50 may comprise multiple coating sub-layers, such as an acrylic primer and silicone hard-coat or a polyurethane coating, in order to enhance the protection of the plastic panel. One specific example of the weathering layer 50 comprising multiple coating sub-layers includes a combination of an acrylic primer 53 (SHP401, GE Silicones, Waterford, N.Y.) and a silicone hard-coat 56 (AS4000, GE Silicones). A variety of additives may be added to the weathering layer 50, such as colorants (tints), Theological control agents, antioxidants, ultraviolet absorbing (UVA) molecules, and IR absorbing or reflecting pigments, among others.

The plastic panel 30 and plastic film 70 may be comprised of any thermoplastic or thermoset polymeric resin. The plastic panel 30 or plastic film 70 should be substantially transparent, but may contain translucent or opaque regions, such as but not limited to an opaque frame or border. The polymeric resins may include, but are not limited to, polycarbonate, acrylic, polyarylate polyester, polysulfone, polyurethane, silicone, epoxy, polyamide, polyalkylenes, and acrylonitrile-butadiene-styrene (ABS), as well as copolymers, blends, and mixtures thereof. The preferred transparent, thermoplastic resins include, but are not limited to, polycarbonate, acrylic, polyarylate, polyester, and polysulfone, as well as copolymers and mixtures thereof. The plastic panel may further comprise various additives, such as colorants, rheological control agents, mold release agents, antioxidants, UVA molecules, and IR absorbing or reflecting pigments, among others.

The abrasion resistant layer 60 comprises a combination of multiple sub-layers with the number of sub-layers being at least two. The first abrasion resistant sub-layer 63 is preferably applied on to the surface of the weatherable layer 50. The second abrasion resistant sub-layer 66 is applied on to the surface of the first abrasion resistant sub-layer 63.

The abrasion resistant layer 60 may be comprised of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof. Preferably, the abrasion resistant layer 60 is comprised of a composition of silicon monoxide, silicon dioxide, silicon oxy-carbide, or hydrogenated silicon oxy-carbide. Thus the abrasion resistant layer 60 may be referred to as a “glass-like” coating.

The abrasion resistant layer 60 may be applied by any vacuum deposition technique known to those skilled in the art, including but not limited to plasma enhanced chemical vapor deposition (PECVD), expanding thermal plasma PECVD, ion assisted plasma deposition, magnetron sputtering, electron beam evaporation, and ion beam sputtering with PECVD being preferred and expanding thermal plasma PECVD being especially preferred.

In one embodiment of the invention, the first abrasion resistant sub-layer 63 is more “organic-like” than the second abrasion-resistant sub-layer layer 66. Although both sub-layers in this embodiment comprise a mixture of silicon, carbon, hydrogen and oxygen atoms, the first abrasion resistant sub-layer 63 comprises a greater amount of carbon and hydrogen atoms than does the second abrasion resistant sub-layer 66. This greater amount or number of carbon and hydrogen atoms makes the first abrasion resistant sub-layer 63 more “organic-like” than the second abrasion resistant sub-layer 66 in order to enhance the adhesion between this layer and the underlying weatherable layer 50.

In one embodiment of the present invention, the second abrasion resistant sub-layer 66 is an “inorganic-like” layer that provides good abrasion resistance. The second abrasion resistant sub-layer 66 comprises more oxygen and silicon atoms, and less carbon and hydrogen atoms, as compared to first abrasion resistant sub-layer 63, thereby providing improved or enhanced abrasion resistance. The chemical nature, as well as the number or amount of the various atoms comprising each abrasion resistant sub-layer can easily be determined by techniques, such as TEM, SIMS, and Auger that are well known to those skilled in the art of material characterization and surface analysis.

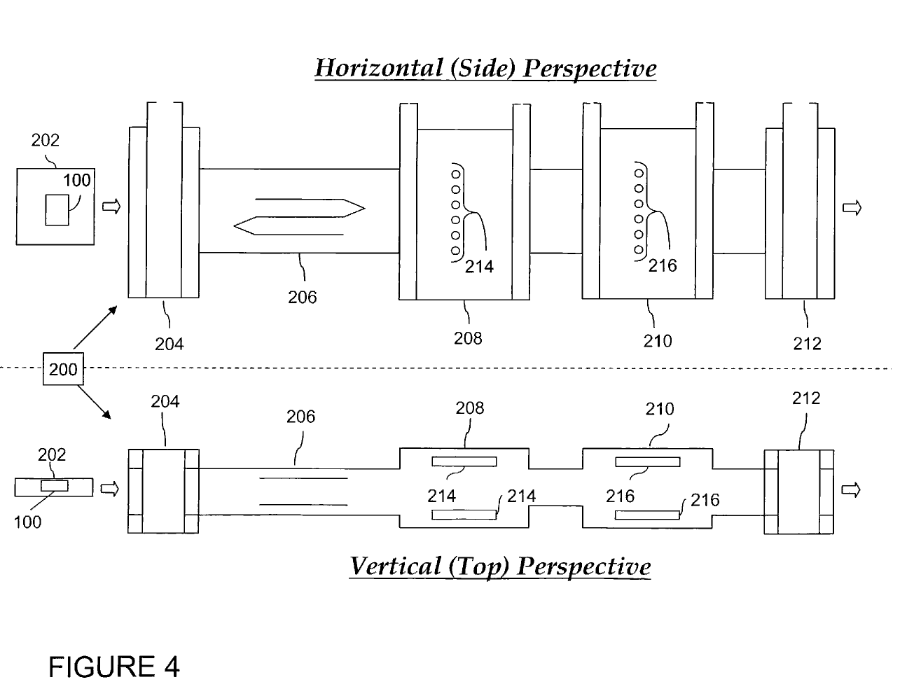

In one preferred embodiment of the present invention, the abrasion-resistant layer is deposited using an expanding thermal plasma PECVD reactor system. This reactor system includes various chambers designed to preheat and apply the abrasion resistant layer 60 onto the first and second surface of an automotive window 100. An expanding thermal plasma PECVD reactor system 200, which is schematically depicted in FIG. 4, has been also explained in U.S. patent application Ser. No. 10/881,949 (filed Jun. 28, 2004 and U.S. patent application Ser. No. 11/075,343(filed Mar. 8, 2005) the entirety of which are hereby incorporated by reference. In an expanding thermal plasma PECVD process, a plasma is generated via applying a direct-current (DC) voltage to a cathode that arcs to a corresponding anode plate in an inert gas environment at pressures higher than 150 Torr, e.g., near atmospheric pressure. The near atmospheric thermal plasma then supersonically expands into a plasma treatment chamber in which the process pressure is less than that in the plasma generator, e.g., about 20 to about 100 mTorr.

FIG. 4 provides both a horizontal (side) view and a vertical (top) view of a part carrier 202 and an expanding thermal plasma PECVD reactor system 200, in accordance with one embodiment of the invention. The part carrier 202 carries a part, such as, for example, a partially manufactured plastic automotive window 100 through the reactor system. The expanding thermal plasma PECVD reactor system 200 includes a load lock chamber 204, a preheat chamber 206, a plurality of coating deposition chambers 208, 210, and an exit lock chamber 212. The coating deposition chambers include a chamber 208 for the deposition of the first abrasion resistant sublayer 63 and a chamber 210 for the deposition of the second abrasion resistant sublayer 66. Additional coating deposition chambers are necessary if more than two sub-layers are used to comprise the abrasion resistant layer 60. Each deposition chamber includes a plurality of arcs 214, 216.

The part carrier 202 carries the plastic automotive window 100 through the various chambers of the expanding thermal plasma PECVD reactor system 200. The part carrier 202 first enters the load lock chamber 204. The load lock chamber 204 includes a load lock pump that reduces the pressure in load lock chamber 204, to create a vacuum substantially similar to the environment present in the coating deposition chambers 208, 210. The part carrier 202 then moves the plastic automotive window into the preheat chamber 206.

The plastic automotive window 100 is heated in the preheat chamber 206 through the use of various heating elements. Examples of heating elements include but are not limited to infrared, microwave, resistance, and non-reactive plasma streams. In one embodiment of the invention, the preheat chamber 206 includes heating bars (resistance heating) placed along the reactor walls. After the surface of the plastic automotive window 100 is heated, the part carrier 202 moves the automotive window through the first coating deposition chamber 208.

In one embodiment of the present invention, the first abrasion resistant sublayer 63 and the second abrasion resistant sublayer 66 are applied in coating deposition chambers 208 and 210, respectively. Each deposition chamber comprises an array of arcs 214, 216. Each of the arcs includes a cathode plate with a centered cathode tip and an anode plate. The plasma is generated by applying a direct current voltage to the cathode plate that arcs to a corresponding anode plate in the presence of a gas or mixture of gases. Examples of gases include argon, nitrogen, ammonia, oxygen, hydrogen, or any combination thereof. The plasma is generated at pressures higher than about 150 Torr. The plasma is then emitted supersonically from the arcs 214, 216, and expanded into the coating deposition chambers 208, 210. In one embodiment of the present invention, the coating deposition chambers 208, 210 have low pressure, such as, for example, in a range of about 20 mTorr to about 100 mTorr. A reactive reagent is oxidized, decomposed, and polymerized in the plasma and deposited on the plastic automotive window 100 to form the abrasion resistant layer 60. Examples of reactive reagents include but are not limited to, octamethylcyclotetrasiloxane (D4), tetramethyldisiloxane (TMDSO), hexamethyldisiloxane (HMDSO), or other volatile organosilicon compounds.

Finally, the part carrier 202, carrying the plastic automotive window 100 coated with the abrasion resistant layer 60, moves into the exit lock chamber 212. The exit lock chamber 212 includes an exit lock pump for evacuation that is similar to the one present in the load lock chamber 204. Upon entry of the part carrier 202 into the exit lock chamber 212, the chamber is at the same low pressure level as the coating deposition chambers 208, 210. Once the part carrier 202 is inside the exit lock chamber 212, the pressure is increased to atmospheric pressure and the part carrier is allowed to exit the expanding thermal plasma PECVD reactor system 200.

The inventors have discovered that the multiple interfaces that exist within the electroluminescent layer 40 are highly sensitive to the application of an abrasion resistant layer 60. More specifically, upon the application of an abrasion resistant layer 60, catastophic adhesion failure between the various interfaces within the electoluminescent layer 40 has been previously encountered. Depending upon the conditions used during the deposition of the abrasion resistant layer 60, the adhesive failure may occur between the phosphor/dielectric sub-layers, the conductive/dielectric sublayers, or the dielectric sublayer and the plastic panel. Adhesive failure between the various interfaces within the electroluminescent layer 40 results in a substantial loss of the desired electroluminescence property. The inventors further discovered that maintaining a uniform heating profile across the multiple sub-layers of the electroluminescent layer 40 was essential to maintaining adhesion between the layers, both during and after the application of an abrasion resistant layer 60. Uniform heating was discovered to be possible by pre-heating the plastic automotive window to a temperature between 35° C. to 65° C., preferably about 50° C. prior to the deposition of the first abrasion resistant sub-layer 63. In the expanding thermal plasma PECVD reactor system shown in FIG. 4, the preheating of the plastic automotive window 100 is done in the pre-heat chamber 206 of the reactor system prior to the window entering the first coating deposition chamber 208.

The inventors have also discovered that limiting the temperature exposure of the electroluminescent layer 40 during the application and curing of the weatherable layer, or during a film insert molding process, enhances the adhesive integrity of the layer and helps to maintain the electroluminescent functionality. Thus, the application and curing of the weatherable layer should preferably be limited to a temperature of less than about 125° C. When a film insert molding (FIM) process is utilized, the temperature of the mold's surface should be maintained at a temperature not exceeding about 85° C.

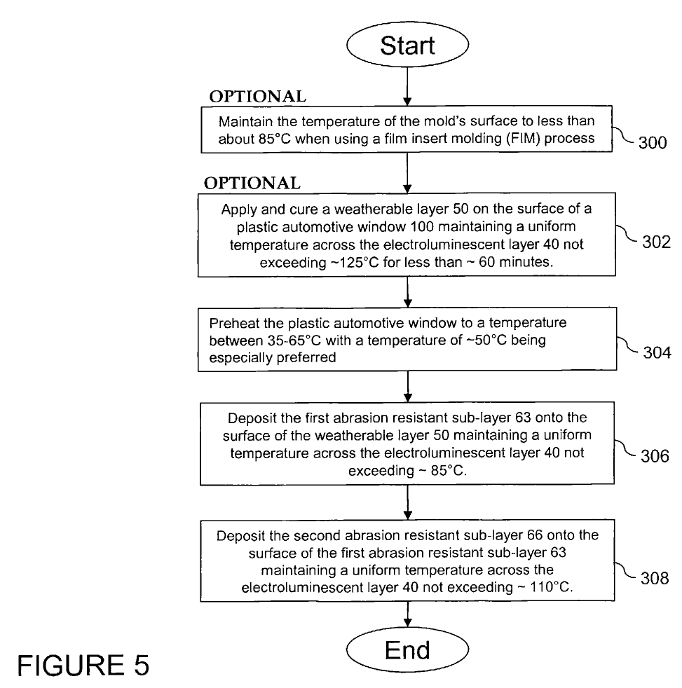

FIG. 5 shows a flowchart illustrating a method for depositing an abrasion resistant layer 60 onto a plastic automotive window 100 that will maintain the integrity (e.g., adhesion between sub-layers) and functionality of the electroluminescent layer 40, in accordance with one preferred embodiment of the present invention. In step 300 a film insert molding process is utilized. In this case, the surface temperature of the mold to which the plastic film 70 and electroluminescent layer 40 is exposed should be maintained at a temperature not exceeding about 85° C. Since a film insert molding process is not always utilized, this process step 300 is optional.

At step 302, the weatherable layer 50 is applied onto the plastic automotive window 100. In this embodiment of the invention, the weatherable layer 50 is applied and cured at a temperature less than about 125° C. for a time period between about 30 and about 75 minutes, with less than about 60 minutes being especially preferred. This process step 302 is also considered optional in that it will enhance the integrity and functionality of the electroluminescent layer 40, but is not as critical as the following three process steps 304-308.

At step 304, the plastic automotive window 100 is preheated prior to the deposition of the first abrasion resistant sub-layer 63. In particular, the plastic automotive window 100 is preheated to a surface temperature in the range of about 35° C. to about 65° C., with a surface temperature of about 50° C. being especially preferred.

At step 306, the first abrasion resistant sub-layer 63 is applied to the surface of the weatherable layer 50 maintaining a uniform temperature across the electroluminescent layer not exceeding about 85° C. In one preferred embodiment of the present invention, where the abrasion resistant layer 60 is deposited using an expanding thermal plasma PECVD reactor system 200, a uniform temperature was discovered to occur when the first abrasion resistant sub-layer 63 is deposited using an arc current in a range from about 30 amps/arc to about 45 ampstarc, a reactive reagent (e.g., octamethylcyclotetrasiloxane, D4) flow in a range of about 110 standard cubic centimeter per minute (sccm) to about 140 sccm, and an oxygen flow in a range of about 250 sccm to about 350 sccm with about 37 amps/arc, a reactive reagent flow of about 125 sccm, and an oxygen flow of about 300 sccm being especially preferred. The preheat temperature, as described at step 304, prevents the surface temperature of plastic automotive window 100 from increasing beyond about 85° C. when the first abrasion resistant sub-layer 63 is applied in step 306

At step 308, the second abrasion resistant sub-layer 66 is applied on top of the first abrasion resistant sub-layer 63 maintaining a uniform temperature across the electroluminescent layer not exceeding about 110° C. In one preferred embodiment of the present invention where the abrasion resistant layer 60 is deposited using an expanding thermal plasma PECVD reactor system, a uniform temperature was discovered to occur when the second abrasion resistant sub-layer 66 is deposited using an arc current in a range from about 30 amps/arc to about 40 amps/arc, a reactive reagent (e.g., octamethylcyclotetrasiloxane, D4) flow in a range of about 110 sccm to about 140 sccm, and an oxygen flow in a range of about 700 sccm to about 900 sccm with about 34 amps/arc, a reactive reagent flow of about 125 sccm, and an oxygen flow of about 800 sccm being especially preferred. The preheat temperature, as described at step 304, and the temperature less than about 85° C. after the deposition of the first abrasion resistant sub-layer 63 in step 306, prevents the surface temperature of the plastic automotive window 100 from increasing beyond 110° C. when the second abrasion resistant sub-layer 66 is applied in step 308.

The various embodiments of the present invention provide an advantageous method and process for the application of an abrasion resistant layer 60 comprising at least two sub-layers 63, 66 to a plastic automotive window 100 comprising an electroluminescent layer 40. The multi-layer glazing system, as described in the present invention, establishes both the adhesive integrity between the electroluminescent sub-layers and the external abrasion resistance necessary to function as a light-emitting automotive window. Furthermore, by limiting the temperature of the mold's surface in a film insert molding process, by limiting the temperature used to cure the weatherable layer, and by preheating the plastic automotive window prior to the deposition of the abrasion resistant layer 60, the occurrence of any adhesion loss between the sub-layers of the electroluminescent layer 40 is either reduced or eliminated.

While the preferred embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described by the appended claims.

1. A method of applying an abrasion resistant layer by vacuum deposition to a plastic automotive window, the method comprising:
providing a plastic automotive window having a plastic panel, an electroluminescent layer deposited over a surface of the plastic panel, and a weatherable layer deposited over a surface of the electroluminescent layer and the plastic panel;
pre-heating the plastic automotive window to a surface temperature within the range of about 35° C. to about 65° C.;
applying a first abrasion resistant sub-layer onto the surface of the weatherable layer while maintaining a surface temperature of the automotive window of less than about 85° C.; and
applying a second abrasion resistant sub-layer onto the first abrasion resistant sub-layer while maintaining a surface temperature of the automotive window of less than about 110° C.

2. The method of claim 1, wherein the plastic automotive window is pre-heated to a surface temperature of about 50° C.

3. The method of claim 1, wherein the plastic panel is selected as one from the group of polycarbonate, acrylic, polyarylate, polyester, polyamide, thermoplastic polyurethane and polysulfone, as well as copolymers and mixtures thereof.

4. The method of claim 1, wherein the weatherable layer is selected as one from the group of silicones, polyurethanes, acrylics, polyarylate, epoxies, and mixtures or copolymers thereof.

5. The method of claim 1, wherein the first abrasion resistant layer is selected as one from the group of silicon monoxide, silicon dioxide, silicon oxy-carbide, or hydrogenated silicon oxy-carbide.

6. The method of claim 1, wherein the second abrasion resistant layer is selected as one from the group of silicon monoxide, silicon dioxide, silicon oxy-carbide, or hydrogenated silicon oxy-carbide.

7. The method of claim 1, wherein the first abrasion resistant sub-layer comprises a greater number of carbon and hydrogen atoms than the second abrasion resistant sub-layer.

8. The method of claim 1, wherein the second abrasion resistant sub-layer comprises a greater number of silicon and oxygen atoms than the first abrasion resistant sub-layer.

9. The method of claim 1 further comprising the step of limiting the temperature at which the weatherable layer is cured to a temperature less than about 125° C. for a period of time less than about 75 minutes.

10. The method of claim 1 further comprising the step of applying the first and second abrasion resistant sub-layers via an expanding thermal plasma PECVD system.

11. The method of claim 10, wherein the first abrasion resistant sub-layer is applied using an arc current in a range from about 30 amps/arc to about 45 amps/arc, a reactive reagent flow in a range from about 110 standard cubic centimeter per minute (sccm) to about 140 sccm, and an oxygen flow in a range from about 250 sccm to about 350 sccm.

12. The method of claim 11, wherein the first abrasion resistant sub-layer is applied using an arc current of about 37 amps/arc, a reactive reagent flow of about 125 sccm, and an oxygen flow of about 300 sccm.

13. The method of claim 10, wherein the second abrasion resistant sub-layer is applied using an arc current in a range from about 30 amps/arc to about 40 amps/arc, a reactive reagent flow in the range from about 110 sccm to about 140 sccm, and an oxygen flow in a range from about 700 sccm to about 900 sccm.

14. The method of claim 13, wherein the second abrasion resistant sub-layer is applied using an arc current of about 34 amps/arc, a reactive reagent flow of about 125 sccm, and an oxygen flow of about 800 sccm.

15. A method of applying an abrasion resistant layer by vacuum deposition to a plastic automotive window, the method comprising:
fabricating a plastic automotive window using a film insert molding (FIM) process while maintaining a mold surface temperature less than about 85° C., the plastic automotive window comprising a plastic panel, an electroluminescent layer deposited over a surface of a plastic film, the plastic film being melt bonded to one side of the plastic panel during the FIM process;
applying a weatherable layer over a surface of the plastic automotive window;
curing the weatherable layer by exposing the plastic automotive window to a temperature that is less than about 125° C. for less than about 75 minutes.
pre-heating the plastic automotive window to a surface temperature within the range of about 35° C. to about 65° C.;
applying a first abrasion resistant sub-layer over the weatherable layer while maintaining a surface temperature of the plastic automotive window of less than about 85° C.; and
applying a second abrasion resistant sub-layer over the first abrasion resistant sub-layer while maintaining a surface temperature of the plastic automotive window of less than about 110° C.

16. The method of claim 15, wherein preheating step preheats the plastic automotive window to a temperature of about 50° C.

17. The method of claim 15, wherein the plastic panel is selected as one from the group of polycarbonate, acrylic, polyarylate, polyester, polyamide, thermoplastic polyurethane and polysulfone, as well as copolymers and mixtures thereof.

18. The method of claim 15, wherein the plastic film is selected as one from the group of polycarbonate, acrylic, polyarylate, polyarglate, and polysulfone, as well as copolymers and mixtures thereof.

19. The method of claim 15, wherein the weatherable layer is selected as one from the group of silicones, polyurethanes, acrylics, polyesters, epoxies, and mixtures or copolymers thereof.

20. The method of claim 15, wherein the first abrasion resistant layer is selected as one from the group of silicon monoxide, silicon dioxide, silicon oxy-carbide, or hydrogenated silicon oxy-carbide.

21. The method of claim 15, wherein the second abrasion resistant layer is selected as one from the group of silicon monoxide, silicon dioxide, silicon oxy-carbide, or hydrogenated silicon oxy-carbide.

22. The method of claim 15, wherein the first abrasion resistant sub-layer comprises a greater number of carbon and hydrogen atoms than the second abrasion resistant sub-layer.

23. The method of claim 15, wherein the second abrasion resistant sub-layer comprises a greater number of silicon and oxygen atoms than the first abrasion resistant sub-layer.

24. The method of claim 15 wherein the steps of applying the first and second abrasion resistant sub-layers includes using an expanding thermal plasma PECVD reactor system.

25. The method of claim 24, wherein the first abrasion resistant sub-layer is applied using an arc current in a range from about 30 amps/arc to about 45 amps/arc, a reactive reagent flow in a range from about 110 standard cubic centimeter per minute (sccm) to about 140 sccm, and an oxygen flow in a range from about 250 sccm to about 350 sccm.

26. The method of claim 25, wherein the first abrasion resistant sub-layer is applied using an arc current of about 37 amps/arc, a reactive reagent flow of about 125 sccm, and an oxygen flow of about 300 sccm.

27. The method of claim 24, wherein the second abrasion resistant sub-layer is applied using an arc current in a range from about 30 amps/arc to about 40 amps/arc, a reactive reagent flow in the range from about 110 sccm to about 140 sccm, and an oxygen flow in a range from about 700 sccm to about 900 sccm.

28. The method of claim 27, wherein the second abrasion resistant sub-layer is applied using an arc current of about 34 amps/arc, a reactive reagent flow of about 125 sccm, and an oxygen flow of about 800 sccm.
